(19) United States
(12) Patent Application Publication
(10) Pub. No.: US 2018/0183630 A1
(43) Pub. Date: Jun. 28, 2018

(54) RECEIVING CIRCUIT, AND SEMICONDUCTOR DEVICE AND SYSTEM CONFIGURED TO USE THE RECEIVING CIRCUIT

(71) Applicant: SK hynix Inc., Icheon-si Gyeonggi-do (KR)

(72) Inventors: Jeong Kyoum KIM, Icheon-si Gyeonggi-do (KR); Jun Yong SONG, Seoul (KR); Han Kyu CHI, Seoul (KR)

(73) Assignee: SK hynix Inc., Icheon-si Gyeonggi-do (KR)

(21) Appl. No.: 15/642,566

(22) Filed: Jul. 6, 2017

(30) Foreign Application Priority Data
Dec. 27, 2016 (KR) 1020160179682

(51) Int. Cl. H04L 25/03

(52) U.S. Cl. CPC H04L 25/03057

(57) ABSTRACT

A receiving circuit may include a decision feedback equalizer circuit and buffer. The buffer may be configured to receive an external signal and to generate an input signal. The decision feedback equalizer circuit may include a plurality of delay circuits, and may be configured to generate an internal signal based on the input signal, a strobe signal, and outputs of the plurality of delay circuits. The plurality of delay circuits may be reset based on whether or not the strobe signal has toggled or not between command signals.

### CROSS-REFERENCES TO RELATED APPLICATION

The present application claims priority under 35 U.S.C. § 119(a) to Korean application number 10-2016-0179682, filed on Dec. 27, 2016, in the Korean Intellectual Property Office, which is incorporated herein by reference in its entirety.

### BACKGROUND

### 1. Technical Field

Various embodiments may generally relate to a semiconductor technology, and, more particularly, to a receiving circuit, and a semiconductor device and system configured to use the receiving circuit.

### 2. Related Art

Electronic apparatuses consist of a large number of electronic components. Among the electronic apparatuses, a computer system consists of many electronic components which are constructed by semiconductor devices. Semiconductor devices which are implemented to construct the computer system may receive and transmit various signals. As the operation speeds of semiconductor devices are increased and the level of a power supply voltage is lowered, the amplitudes of the signals transferred between a plurality of semiconductor devices gradually decrease. Thus, a receiving device and a transmitting device capable of receiving and transmitting precise signals have been developed. For example, a receiving device and a transmitting device may include a decision feedback equalizer, and correct a signal to be received or transmitted.

### SUMMARY

In an embodiment, a receiving circuit may be provided. The receiving circuit may include a reset control circuit configured to generate a plurality of reset signals based on operation information. The receiving circuit may include a buffer configured to receive an external signal and to generate an input signal. The receiving circuit may include a decision feedback equalizer circuit including a plurality of delay circuits, and configured to generate an internal signal based on the input signal and outputs of the plurality of delay circuits. The plurality of delay circuits may be reset based on the plurality of reset signals, respectively.

In an embodiment, a receiving circuit may be provided. The receiving circuit may include a reset signal generation circuit configured to generate a first reset signal, a second reset signal, a third reset signal and a fourth reset signal based on a time information, a burst length information and a burst chop information. The receiving circuit may include a buffer configured to receive an external signal and to generate an input signal. The receiving circuit may include a decision feedback equalizer circuit including a first delay circuit, a second delay circuit, a third delay circuit and a fourth delay circuit, and configured to generate an internal signal based on the input signal and first to fourth feedback signals respectively generated from the first to fourth delay circuits. The first to fourth delay circuits may be reset based on the first to fourth reset signals.

In an embodiment, a receiving circuit may be provided. The receiving circuit may include a decision feedback equalizer circuit and buffer. The buffer may be configured to receive an external signal and to generate an input signal. The decision feedback equalizer circuit may include a plurality of delay circuits, and may be configured to generate an internal signal based on the input signal, a strobe signal, and outputs of the plurality of delay circuits. The plurality of delay circuits may be reset based on whether or not the strobe signal has toggled or not between command signals.

### BRIEF DESCRIPTION OF THE DRAWINGS

FIG. 1 is a diagram illustrating a representation of an example of the configuration of a system in accordance with an embodiment.

FIG. 2 is a diagram illustrating a representation of an example of the configuration of a receiving circuit in accordance with an embodiment.

FIG. 3 is a diagram illustrating a representation of an example of the configuration of the reset control circuit illustrated in FIG. 2.

FIG. 4 is a diagram illustrating a representation of an example of the configuration of a receiving circuit in accordance with an embodiment.

FIGS. 5A to 5D are representations of examples of diagrams to assist in the explanation of the operations of the receiving circuit and the semiconductor system depending on operation informations.

FIG. 6 is a representation of an example of a diagram to assist in the explanation of the operations of the receiving circuit and the semiconductor system depending on operation informations.

FIG. 7 is a diagram illustrating a representation of an example of the configuration of a receiving circuit in accordance with an embodiment.

FIG. 8 is a representation of an example of a table to assist in the explanation of the operation of the reset control circuit illustrated in FIG. 7.

### DETAILED DESCRIPTION

Hereinafter, a receiving circuit, and semiconductor device and a system using the same will be described below with reference to the accompanying drawings through various examples of embodiments.

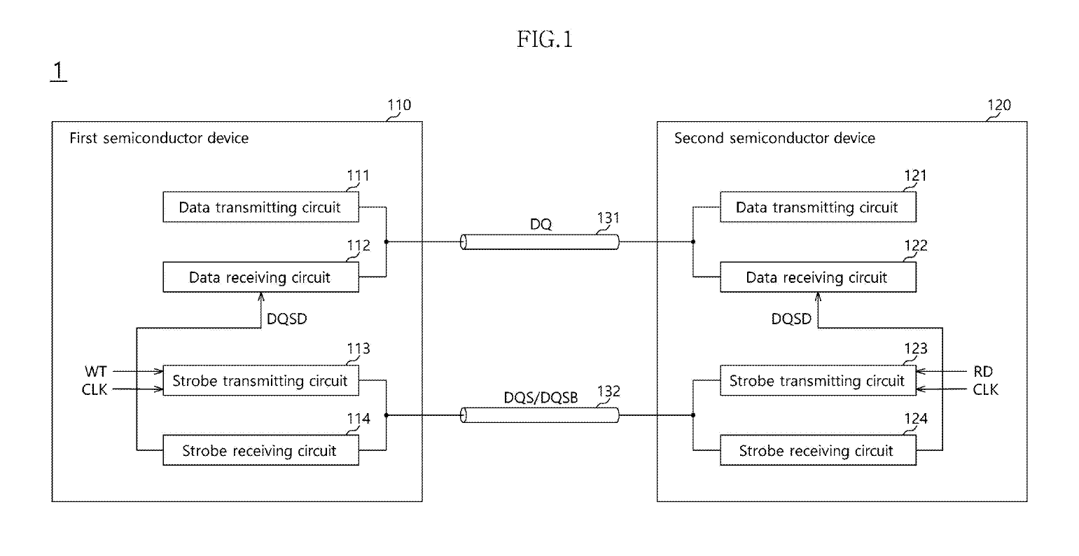

FIG. 1 is a diagram illustrating a representation of an example of the configuration of a system 1 in accordance with an embodiment. Referring to FIG. 1, the system 1 in accordance with an embodiment may include a first semiconductor device 110 and a second semiconductor device 120. The first semiconductor device 110 and the second semiconductor device 120 may be electronic components which communicate with each other. In an embodiment, the first semiconductor device 110 may be a master device, and the second semiconductor device 120 may be a slave device which operates by being controlled by the first semiconductor device 110. For example, the first semiconductor device 110 may be a host device such as a processor, and the processor may include, for example but not limited to, a central processing unit (CPU), a graphic processing unit (GPU), a multimedia processor (MMP) or a digital signal processor (DSP). Also, the first semiconductor device 110 may be realized in the form of a system-on-chip (SOC) by combining processor chips having various functions, such as application processors (APs). The second semiconductor device 120 may be a memory, and the memory may include a volatile memory or a nonvolatile memory. The volatile memory may include, for example but not limited to, an SRAM (static RAM), a DRAM (dynamic RAM) or an SDRAM (synchronous DRAM), and the nonvolatile memory may include a ROM (read only memory), a PROM (programmable ROM), an EEPROM (electrically erasable and programmable ROM), an EPROM (electrically programmable ROM), a flash memory, a PRAM (phase change RAM), an MRAM (magnetic RAM), an RRAM (resistive RAM) or an FRAM (ferroelectric RAM).

The first and second semiconductor devices 110 and 120 may be coupled with each other through a plurality of signal transmission lines 131 and 132. The signal transmission lines 131 and 132 may be channels, links or buses. A first signal transmission line 131 may be a data bus which transmits data DQ. A second signal transmission line 132 may be a strobe bus or a clock bus which transmits a clock signal such as a strobe signal DQS/DQSB. Hereafter, signals transmitted through the first and second signal transmission lines 131 and 132 may be referred to as external signals, and signals generated in the first and second semiconductor devices 110 and 120 may be referred to as internal signals. The first semiconductor device 110 may include a data transmitting circuit 111, a data receiving circuit 112, a strobe transmitting circuit 113, and a strobe receiving circuit 114. The data transmitting circuit and strobe transmitting circuit 111 and 113 may generate output signals according to an internal signal of the first semiconductor device 110, and transmit the output signals to the second semiconductor device 120 through the signal transmission lines 131 and 132, respectively. The data transmitting circuit 111 may transmit the data DQ to the second semiconductor device 120 through the first signal transmission line 131. The strobe transmitting circuit 113 may generate the strobe signal DQS/DQSB or a clock signal which is synchronized with a point of time at which the data DQ is outputted, and transmit the strobe signal DQS/DQSB to the second semiconductor device 120 through the second signal transmission line 132. The data receiving circuit and strobe receiving circuit 112 and 114 may receive signals transmitted from the second semiconductor device 120 through the signal transmission lines 131 and 132, respectively, and generate an internal signal. The data receiving circuit 112 may receive the data DQ transmitted through the first signal transmission line 131, and generate the internal signal. The strobe receiving circuit 114 may receive the strobe signal DQS/DQSB transmitted through the second signal transmission line 132, and generate a strobe signal DQSD or a clock signal which is needed in generating the internal signal.

The second semiconductor device 120 may include a data transmitting circuit 121, a data receiving circuit 122, a strobe transmitting circuit 123, and a strobe receiving circuit 124. The data transmitting circuit and strobe transmitting circuit 121 and 123 may generate output signals according to an internal signal of the second semiconductor device 120, and transmit the output signals to the first semiconductor device 110 through the signal transmission lines 131 and 132, respectively. The data transmitting circuit 121 may generate the data DQ, and transmit the data DQ to the first semiconductor device 110 through the first signal transmission line 131. The strobe transmitting circuit 123 may generate the strobe signal DQS/DQSB which is synchronized with a point of time at which the data DQ is outputted, and transmit the strobe signal DQS to the first semiconductor device 110 through the second signal transmission line 132. The data receiving circuit and strobe receiving circuit 122 and 124 may receive signals transmitted from the first semiconductor device 110 through the signal transmission lines 131 and 132, respectively, and generate an internal signal. The data receiving circuit 122 may receive the data DQ transmitted through the first signal transmission line 131, and generate the internal signal. The strobe receiving circuit 124 may receive the strobe signal DQS/DQSB transmitted through the second signal transmission line 132, and generate the strobe signal DQSD which is needed in generating the internal signal.

The strobe transmitting circuit 113 may generate the strobe signal DQS/DQSB based on operation information and a clock signal CLK. When an operation for the first semiconductor device 110 to transmit data DQ to the second semiconductor device 120 is defined as a write operation, the operation informations may be informations associated with the write operation. The strobe transmitting circuit 113 may generate the strobe signal DQS/DQSB based on a write signal WT and the clock signal CLK. The strobe transmitting circuit 123 may generate the strobe signal DQS/DQSB based on operation information and the clock signal CLK. When an operation for the second semiconductor device 120 to transmit data DQ to the first semiconductor device 110 is defined as a read operation, the operation informations may be informations associated with the read operation. The strobe transmitting circuit 123 may generate the strobe signal DQS/DQSB based on a read signal RD and the clock signal CLK.

The strobe receiving circuit 114 may delay the strobe signal DQS/DQSB received through the second signal transmission line 132, and generate the strobe signal DQSD. The strobe receiving circuit 114 may include a delay which delays the strobe signal DQS/DQSB and generates the strobe signal DQSD. The strobe receiving circuit 114 may provide the strobe signal DQSD to the data receiving circuit 112. The strobe receiving circuit 124 may delay the strobe signal DQS/DQSB received through the second signal transmission line 132, and generate the strobe signal DQSD. The strobe receiving circuit 124 may include a delay which delays the strobe signal DQS/DQSB and generates the strobe signal DQSD. The strobe receiving circuit 124 may provide the strobe signal DQSD to the data receiving circuit 122.

The first and second semiconductor devices 110 and 120 may perform serial communication, and the signal transmission line 131 may transmit data of a serial type. In order to quickly process data of a large capacity, the first and second semiconductor devices 110 and 120 may convert data of a serial type into data of a parallel type and use the converted data of a parallel type. The data DQ may be serial data, and the internal signal generated from the data DQ may be parallel data. Each of the data transmitting circuits 111 and 121 may include a serializer for converting the internal signal of a parallel type into the data DQ of a serial type. Each of the data receiving circuits 112 and 122 may include a parallelizer for converting the data DQ of a serial type into the internal signal of a parallel type.

The data receiving circuits 112 and 122 may receive the data DQ in synchronization with the strobe signal DQSD. Each of the data receiving circuits 112 and 122 may include a decision feedback equalizer circuit. The decision feedback equalizer circuit may be used to correct a distortion or an error occurred in a received signal when the data DQ transmitted through the first signal transmission line 131 is received. As each of the data receiving circuits 112 and 122 adopts the decision feedback equalizer circuit, it may be possible to generate a precise and integral internal signal.

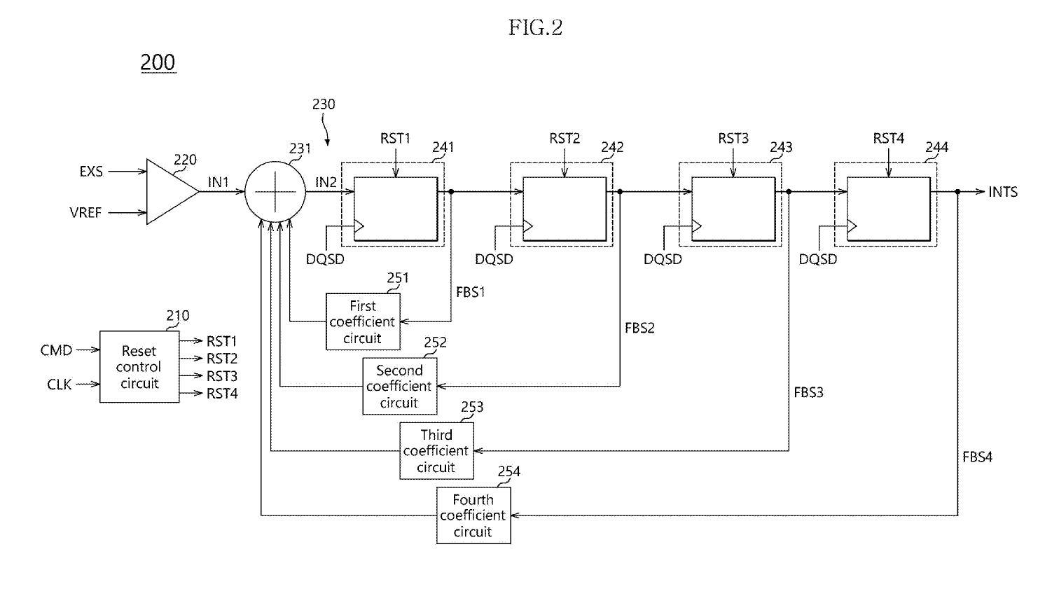

FIG. 2 is a diagram illustrating a representation of an example of the configuration of a receiving circuit 200 in accordance with an embodiment. The receiving circuit 200 illustrated in FIG. 2 may be applied as each of the data receiving circuits 112 and 122 illustrated in FIG. 1. Referring to FIG. 2, the receiving circuit 200 may include a reset control circuit 210, a buffer 220, and a decision feedback equalizer circuit 230. The reset control circuit 210 may is generate a plurality of reset signals RST1, RST2, RST3 and RST4 depending on operation information of a semiconductor device. The operation information of the semiconductor device may include various information. The operation information of the semiconductor device may be generated based on a command CMD which is received by the semiconductor device. For example, the operation information may include a tCCD, burst length information and burst chop information. The tCCD may be time information from a point of time at which a previous command is inputted to a point of time at which a next command is inputted. For example, the tCCD may be time information which defines a time interval from after a write command signal as a command instructing a previous write operation is inputted to a point of time at which a write command signal instructing a next write operation is inputted, when write operations of the semiconductor device are performed successively. A burst length may define the number of data bits which are inputted successively in an operation performed based on one command. For example, after a write command signal instructing a write operation is inputted, 8-bit data may be inputted successively for the write operation, and at this time, the burst length may be defined as 8. A burst chop may define the number of data bits which are not used in a burst length. For example, in the case where a burst length is 8 and a burst chop is 4, 4-bit data may be inputted successively for a write operation after a write command signal is inputted. The reset control circuit 210 may generate the plurality of reset signals RST1, RST2, RST3 and RST4 based on time information TS which may be defined as the tCCD, a burst length information BL and a burst chop information BC. The reset control circuit 210 may use a clock signal CLK to generate the time information TS from the command CMD.

The buffer 220 may buffer an external signal EXS, and generate an input signal IN1. The buffer 220 may be coupled with a signal transmission line such as the signal transmission line 131 illustrated in FIG. 1, receive the external signal EXS transmitted through the signal transmission line, and generate the input signal IN1. The external signal EXS may be, for example, data. The external signal EXS may be a single-ended signal or a pair of differential signals. The buffer 220 may be a differential amplification circuit. When the external signal EXS is a single-ended signal, the buffer 220 may differentially amplify the external signal EXS and a reference voltage VREF, and generate the input signal IN1. The reference voltage VREF may have a voltage level corresponding to the middle of the swing width of the external signal EXS. When the external signal EXS is a pair of differential signals, the buffer 220 may not use the reference voltage VREF, and generate the input signal IN1 by amplifying the pair of differential signals.

The decision feedback equalizer circuit 230 may generate an internal signal INTS from the input signal IN1. The decision feedback equalizer circuit 230 may generate the internal signal INTS by correcting the input signal IN1. The decision feedback equalizer circuit 230 may include a plurality of delay circuits. The decision feedback equalizer circuit 230 may generate the internal signal INTS by correcting the input signal IN1 based on the outputs of the plurality of delay circuits. The plurality of delay circuits may be reset by the plurality of reset signals RST1, RST2, RST3 and RST4 which are generated by the reset control circuit 210.

Referring to FIG. 2, the decision feedback equalizer circuit 230 may include a summer 231, a first delay circuit 241, a second delay circuit 242, a third delay circuit 243, and a fourth delay circuit 244. While it is illustrated in FIG. 2 that the decision feedback equalizer circuit 230 includes four delay circuits, it is to be noted that that the embodiments are not limited thereto and more or less delay circuits may be implemented. According to an application example, the decision feedback equalizer circuit 230 may include at least two delay circuits. The summer 231 may receive the output of the buffer 220, and generate a corrected signal IN2 from the input signal IN1 by being fed back with the outputs of the first to fourth delay circuits 241, 242, 243 and 244. The summer 231 may receive the input signal IN1, a first feedback signal FBS1, a second feedback signal FBS2, a third feedback signal FBS3 and a fourth feedback signal FBS4, and generate the corrected signal IN2 by summing the signals. The summer 231 may generate the corrected signal IN2 by amplifying the input signal IN1 and changing the voltage level of an amplified signal based on the first to fourth feedback signals FBS1, FBS2, FBS3 and FBS4. The summer 231 may be realized by using any circuit known in the art before the present embodiment is filed.

The first delay circuit 241 may receive the corrected signal IN2 and generate the first feedback signal FBS1. The first delay circuit 241 may generate the first feedback signal FBS1 from the corrected signal IN2 based on a strobe signal DQSD. The first delay circuit 241 may output the corrected signal IN2 as the first feedback signal FBS1 in synchronization with the strobe signal DQSD. The first delay circuit 241 may be realized by a flip-flop circuit. The strobe signal DQSD may correspond to the strobe signal DQSD which is generated from the strobe receiving circuits 114 and 124 illustrated in FIG. 1. The strobe signal DQSD may be a clock signal which toggles in synchronization with data, or a clock signal which toggles only when data is received. Accordingly, the strobe signal DQSD may toggle only while the external signal EXS is inputted.

The second delay circuit 242 may receive the first feedback signal FBS1, and generate the second feedback signal FBS2. The second delay circuit 242 may generate the second feedback signal FBS2 from the first feedback signal FBS1 based on the strobe signal DQSD. The second delay circuit 242 may output the first feedback signal FBS1 as the second feedback signal FBS2 in synchronization with the strobe signal DQSD. The second delay circuit 242 may be realized by a flip-flop circuit. The third delay circuit 243 may receive the second feedback signal FBS2, and generate the third feedback signal FBS3. The third delay circuit 243 may generate the third feedback signal FBS3 from the second feedback signal FBS2 based on the strobe signal DQSD. The third delay circuit 243 may output the second feedback signal FBS2 as the third feedback signal FBS3 in synchronization with the strobe signal DQSD. The third delay circuit 243 may be realized by a flip-flop circuit. The fourth delay circuit 244 may receive the third feedback signal FBS3, and generate the fourth feedback signal FBS4. The fourth delay circuit 244 may generate the fourth feedback signal FBS4 from the third feedback signal FBS3 based on the strobe signal DQSD. The fourth delay circuit 244 may output the third feedback signal FBS3 as the fourth feedback signal FBS4 in synchronization with the strobe signal DQSD. The fourth delay circuit 244 may be realized by a flip-flop circuit. The fourth feedback signal FBS4 may be provided as the internal signal INTS.

The plurality of reset signals RST1, RST2, RST3 and RST4 may include a first reset signal RST1, a second reset signal RST2, a third reset signal RST3, and a fourth reset signal RST4. The first delay circuit 241 may be reset based on the first reset signal RST1. The first delay circuit 241 may reset the level of the first feedback signal FBS1 to a specified level based on the first reset signal RST1. The second delay circuit 242 may be reset based on the second reset signal RST2. The second delay circuit 242 may reset the level of the second feedback signal FBS2 to a specified level based on the second reset signal RST2. The third delay circuit 243 may be reset based on the third reset signal RST3. The third delay circuit 243 may reset the level of the third feedback signal FBS3 to a specified level based on the third reset signal RST3. The fourth delay circuit 244 may be reset based on the fourth reset signal RST4. The fourth delay circuit 244 may reset the level of the fourth feedback signal FBS4 to a specified level based on the fourth reset signal RST4.

Referring to FIG. 2, the decision feedback equalizer circuit 230 may further include a first coefficient circuit 251, a second coefficient circuit 252, a third coefficient circuit 253, and a fourth coefficient circuit 254. The first coefficient circuit 251 may receive the first feedback signal FBS1, compute the first feedback signal FBS1 and a first coefficient, and provide a computed result to the summer 231. The first coefficient may define the weight of the first feedback signal FBS1 for generating the corrected signal IN2. For example, the first coefficient circuit 251 may multiply the first feedback signal FBS1 and the first coefficient. The second coefficient circuit 252 may receive the second feedback signal FBS2, compute the second feedback signal FBS2 and a second coefficient, and provide a computed result to the summer 231. The second coefficient may define the weight of the second feedback signal FBS2 for generating the corrected signal IN2. For example, the second coefficient circuit 252 may multiply the second feedback signal FBS2 and the second coefficient. The third coefficient circuit 253 may receive the third feedback signal FBS3, compute the third feedback signal FBS3 and a third coefficient, and provide a computed result to the summer 231. The third coefficient may define the weight of the third feedback signal FBS3 for generating the corrected signal IN2. For example, the third coefficient circuit 253 may multiply the third feedback signal FBS3 and the third coefficient. The fourth coefficient circuit 254 may receive the fourth feedback signal FBS4, compute the fourth feedback signal FBS4 and a fourth coefficient, and provide a computed result to the summer 231. The fourth coefficient may define the weight of the fourth feedback signal FBS4 for generating the corrected signal IN2. For example, the fourth coefficient circuit 254 may multiply the fourth feedback signal FBS4 and the fourth coefficient.

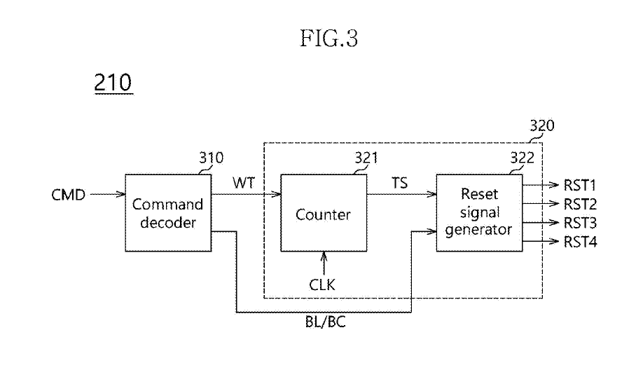

FIG. 3 is a diagram illustrating a representation of an example of the configuration and operation of the reset control circuit 210 illustrated in FIG. 2. Referring to FIG. 3, the reset control circuit 210 may include a command decoder 310 and a reset signal generation circuit 320. The command decoder 310 may receive the command CMD which is transmitted from an external device, and generate a write signal WT and the operation information. The command CMD may include a plurality of signals, and the command decoder 310 may generate the write signal WT by decoding the plurality of signals. Also, the command decoder 310 may generate the burst length information BL and the burst chop information BC among the operation information, based on the command CMD.

The reset signal generation circuit 320 may generate the plurality of reset signals RST1, RST2, RST3 and RST4 based on the write signal WT, the burst length information BL and the burst chop information BC. The reset signal generation circuit 320 may include a counter 321 and a reset signal generator 322. The counter 321 may receive the write signal WT and the clock signal CLK, and generate the time information TS. The counter 321 may receive the write signal WT, and perform a counting operation based on the clock signal CLK. The counter 321 may output a time interval from a point of time at which a previous write signal WT is inputted to a point of time at which a next write signal WT is inputted, as the time information TS. The reset signal generator 322 may generate the plurality of reset signals RST1, RST2, RST3 and RST4 based on the time information TS, the burst length information BL and the burst chop information BC. The reset signal generator 322 may enable selectively the first to fourth reset signals RST1, RST2, RST3 and RST4 depending on the time information TS, the burst length information BL and the burst chop information BC.

The semiconductor device may perform a plurality of write operations successively. If a time interval between a previous write operation and a next write operation is long, a malfunction may occur in a decision feedback equalizer circuit. For example, the first to fourth delay circuits 241, 242, 243 and 244 of the decision feedback equalizer circuit 230 may retain the levels of the first to fourth feedback signals FBS1, FBS2, FBS3 and FBS4 based on the external signal EXS received in a previous write operation. This is because, while the first to fourth delay circuits 241, 242, 243 and 244 operate in synchronization with the strobe signal DQSD, the strobe signal DQSD does not toggle when the external signal EXS is inputted. Therefore, the first to fourth delay circuits 241, 242, 243 and 244 may not be reset by themselves, and may retain the levels of the first to fourth feedback signals FBS1, FBS2, FBS3 and FBS4 which have been outputted previously. At this time, if the external signal EXS for a next write operation is inputted after a certain time, since the first to fourth feedback signals FBS1, FBS2, FBS3 and FBS3 have the levels based on the external signal EXS received in a previous write operation, correction of the currently inputted external signal EXS may be performed in an undesired manner. Thus, in the receiving circuit 200 in accordance with an embodiment, by resetting the delay circuits of the decision feedback equalizer circuit 230 depending on the operation information of the semiconductor device, a malfunction may be prevented, and the precise internal signal INTS may be generated.

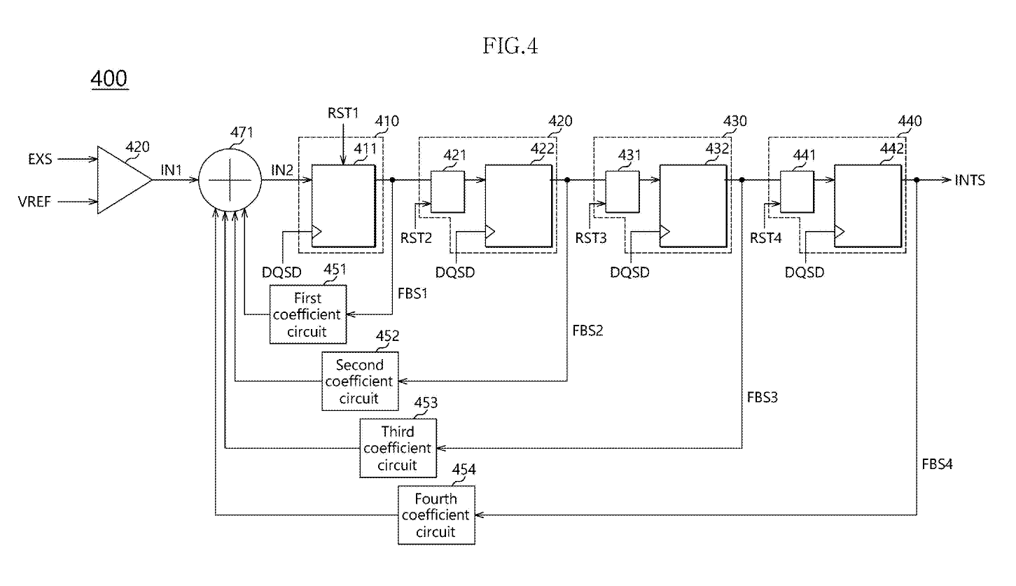

FIG. 4 is a diagram illustrating a representation of an example of the configuration of a receiving circuit 400 in accordance with an embodiment. The receiving circuit 400 of FIG. 4 may have substantially the same configuration as the receiving circuit 200 of FIG. 2 except the configurations of delay circuits. Repeated descriptions for the same components will be omitted herein. Referring to FIG. 4, the receiving circuit 400 may include first to fourth delay circuits 410, 420, 430 and 440, first to fourth coefficient circuits 451, 452, 453, and 454, and a summer 471. Similarly to the first delay circuit 241 of FIG. 2, the first delay circuit 410 may include a first flip-flop 411 which receives a first reset signal RST1. The first flip-flop 411 may output a corrected signal IN2 as a first feedback signal FBS1 in synchronization with a strobe signal DQSD. The first flip-flop 411 may be reset based on the first reset signal RST1.

The second delay circuit 420 may include a first input logic 421 and a second flip-flop 422. The first input logic 421 may receive a second reset signal RST2, and change the level of a second feedback signal FBS2. The first input logic 421 may output selectively the first feedback signal FBS1 to the second flip-flop 422 based on the second reset signal RST2. The first input logic 421 may receive the first feedback signal FBS1 and the second reset signal RST2. The first input logic 421 may output the first feedback signal FBS1 to the second flip-flop 422 when the second reset signal RST2 is a disabled state. The first input logic 421 may not output the first feedback signal FBS1 to the second flip-flop 422 when the second reset signal RST2 is an enabled state. Accordingly, the second flip-flop 422 may reset the level of the second feedback signal FBS2 to a specified level in synchronization with the strobe signal DQSD when the first feedback signal FBS1 is not received from the first input logic 421.

The third delay circuit 430 may include a second input logic 431 and a third flip-flop 432. The second input logic 431 may receive a third reset signal RST3, and change the level of a third feedback signal FBS3. The second input logic 431 may output selectively the second feedback signal FBS2 to the third flip-flop 432 based on the third reset signal RST3. The second input logic 431 may receive the second feedback signal FBS2 and the third reset signal RST3. The second input logic 431 may output the second feedback signal FBS2 to the third flip-flop 432 when the third reset signal RST3 is a disabled state. The second input logic 431 may not output the second feedback signal FBS2 to the third flip-flop 432 when the third reset signal RST3 is an enabled state. Accordingly, the third flip-flop 432 may reset the level of the third feedback signal FBS3 to a specified level in synchronization with the strobe signal DQSD when the second feedback signal FBS2 is not received from the second input logic 431.

The fourth delay circuit 440 may include a third input logic 441 and a fourth flip-flop 442. The third input logic 441 may receive a fourth reset signal RST4, and change the level of a fourth feedback signal FBS4. The third input logic 441 may output selectively the third feedback signal FBS3 to the fourth flip-flop 442 based on the fourth reset signal RST4. The third input logic 441 may receive the third feedback signal FBS3 and the fourth reset signal RST4. The third input logic 441 may output the third feedback signal FBS3 to the fourth flip-flop 442 when the fourth reset signal RST4 is a disabled state. The third input logic 441 may not output the third feedback signal FBS3 to the fourth flip-flop 442 when the fourth reset signal RST4 is an enabled state. Accordingly, the fourth flip-flop 442 may reset the level of the fourth feedback signal FBS4 to a specified level in synchronization with the strobe signal DQSD when the third feedback signal FBS3 is not received from the third input logic 441.

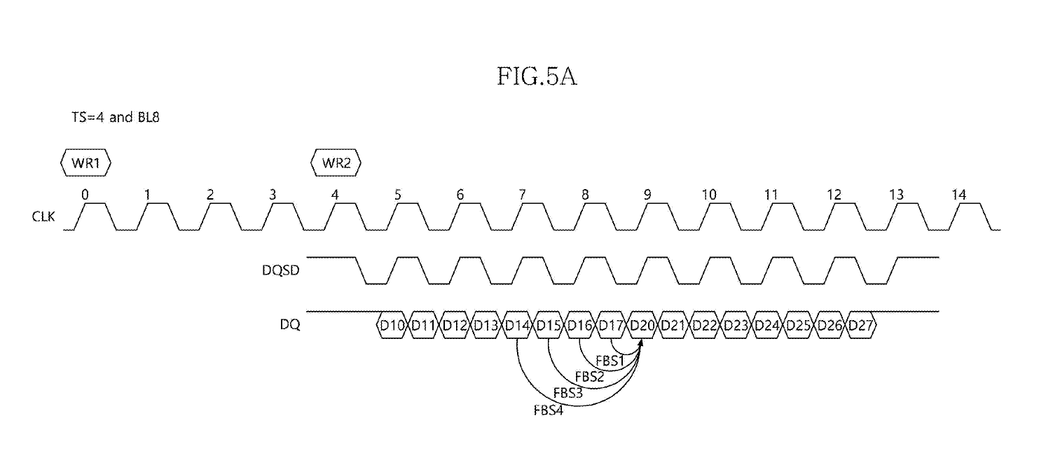

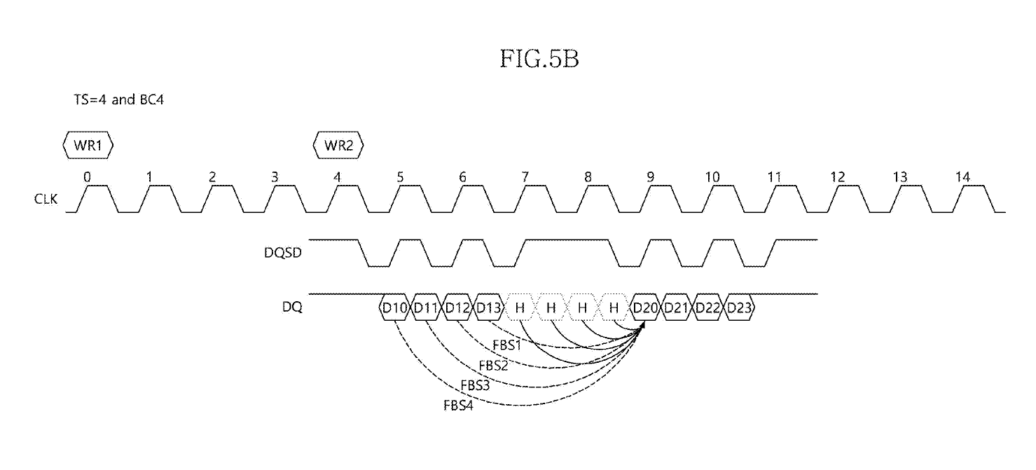

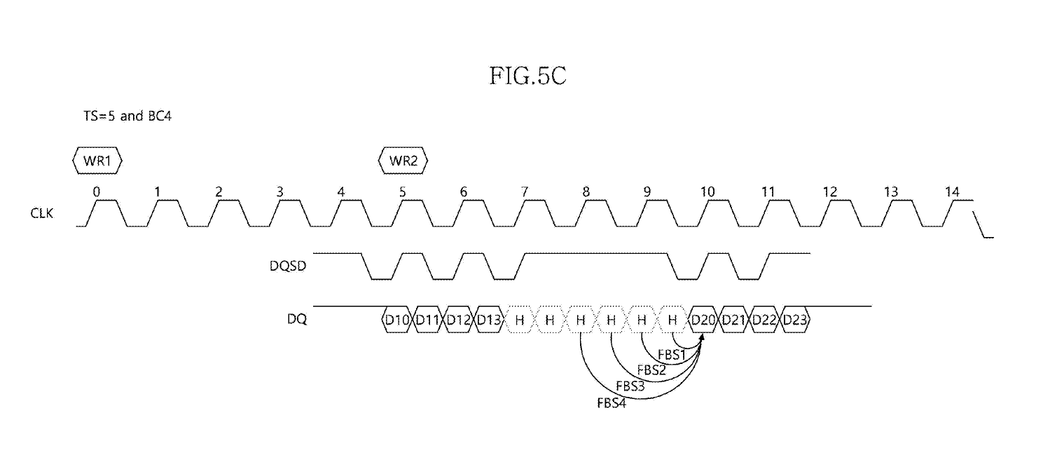

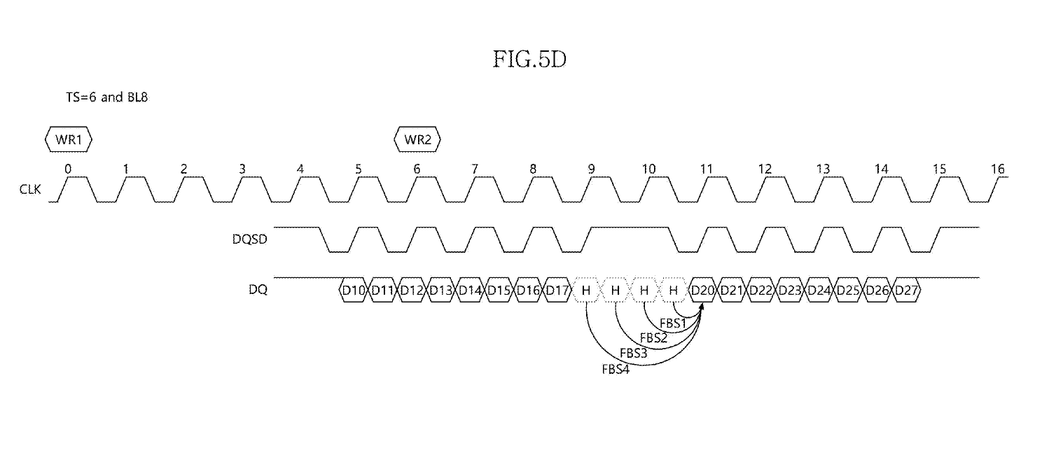

FIGS. 5a to 5d are representations of examples of timing diagrams to assist in the explanation of the operations of the receiving circuit 200 and the semiconductor system 1 in accordance with the embodiment, depending on operation information. The receiving circuit 400 may operate substantially the same as the receiving circuit 200. The operations of the receiving circuit 200 and the semiconductor system 1 in accordance with an embodiment will be described below with reference to FIGS. 1 to 5d. Referring to FIGS. 5a to 5d, the external signal EXS may be data DQ, and the data DQ may be synchronized with the strobe signal DQSD. The first semiconductor device 110 may provide write command signals WR1 and WR2 as commands CMD such that the second semiconductor device 120 performs write operations successively. FIG. 5a is a timing diagram illustrating operations when time information is 4 (TS=4) and a burst length information is 8 (BL8). When time information is 4 (TS=4) and a burst length information is 8 (BL8), the second write command signal WR2 may be inputted when four cycles of the clock signal CLK pass after the first write command signal WR1 is inputted. Data D10, D11, D12, D13, D14, D15, D16 and D17 associated with a first write operation may be inputted in synchronization with the rising edge and the falling edge of the strobe signal DQSD in fifth to eighth cycles of the clock signal CLK. Data D20, D21, D22, D23, D24, D25, D26 and D27 associated with a second write operation may be inputted in synchronization with the rising edge and the falling edge of the strobe signal DQSD in ninth to twelfth cycles of the clock signal CLK. Therefore, a period in which the strobe signal DQSD does not toggle does not exist, and the first to fourth delay circuits 241, 242, 243 and 244 need not be reset. Hence, the reset control circuit 210 may disable all the first to fourth reset signals RST1, RST2, RST3 and RST4. Fifth to eighth data D14, D15, D16 and D17 associated with the first write operation may be used as the first to fourth feedback signals FBS1, FBS2, FBS3 and FBS4 for a decision feedback equalizing operation when receiving first data D20 associated with the second write operation.

FIG. 5b is a timing diagram illustrating operations of the receiving circuit 200 and the semiconductor system 1 when time information is 4 (TS=4) and a burst chop information is 4 (BC4). Data D10, D11, D12 and D13 associated with a first write operation may be inputted in synchronization with the rising edge and the falling edge of the strobe signal DQSD in fifth and sixth cycles of the clock signal CLK. Data D20, D21, D22 and D23 associated with a second write operation may be inputted in synchronization with the rising edge and the falling edge of the strobe signal DQSD in ninth and tenth cycles of the clock signal CLK. The strobe signal DQSD may not toggle in seventh and eighth cycles of the clock signal CLK. As illustrated in FIG. 5b, since data DQ is not received in the seventh and eighth cycles, decision feedback equalization is not needed when first data D20 associated with the second write operation is received. In a period in which data DQ is not received, data is denoted by H. When the strobe signal DQSD does not toggle and delay circuits are not reset, since the first to fourth delay circuits 241, 242, 243 and 244 retain the levels of the first to fourth feedback signals FBS1, FBS2, FBS3 and FBS4 based on the levels of first to fourth data D10, D11, D12 and D13 associated with the first write operation, a problem may be caused in that decision feedback equalization is performed according to the levels of the first to fourth data D10, D11, D12 and D13 associated with the first write operation. In an embodiment, the reset control circuit 210 may reset the first to fourth delay circuits 241, 242, 243 and 244 by enabling the first to fourth reset signals RST1, RST2, RST3 and RST4. Thus, it may be possible to prevent decision feedback equalization from being performed based on the data D10, D11, D12 and D13 associated with the first write operation.

FIG. 5c is a timing diagram illustrating operations of the receiving circuit 200 and the semiconductor system 1 when a time information is 5 (TS=5) and a burst chop information is 4 (BC4). Data D10, D11, D12 and D13 associated with a first write operation may be inputted in synchronization with the strobe signal DQSD in fifth and sixth cycles of the clock signal CLK, and data D20, D21, D22 and D23 associated with a second write operation may be inputted in synchronization with the strobe signal DQSD in tenth and eleventh cycles of the clock signal CLK. Therefore, in seventh to ninth cycles of the clock signal CLK, the strobe signal DQSD may not toggle and also data DQ may not be received. The reset control circuit 210 may reset the first to fourth delay circuits 241, 242, 243 and 244 by enabling the first to fourth reset signals RST1, RST2, RST3 and RST4 such that first to fourth data D10, D11, D12 and D13 associated with the first write operation do not exert any influence when receiving first data D20 associated with the second write operation.

FIG. 5d is a timing diagram illustrating operations of the receiving circuit 200 and the semiconductor system 1 when a time information is 6 (TS=6) and a burst length information is 8 (BL8). Data D10, D11, D12, D13, D14, D15, D16 and D17 associated with a first write operation may be inputted in fifth to eighth cycles of the clock signal CLK, and data D20, D21, D22, D23, D24, D25, D26 and D27 associated with a second write operation may be inputted in eleventh to fourteenth cycles of the clock signal CLK. In ninth and tenth cycles of the clock signal CLK, the strobe signal DQSD may not toggle and also data DQ may not be received. Thus, the reset control circuit 210 may reset the first to fourth delay circuits 241, 242, 243 and 244 by enabling the first to fourth reset signals RST1, RST2, RST3 and RST4. When a burst chop information is 4 (BC4) or a time information is equal to or larger than 7 (TS=7 or over), since the strobe signal DQSD does not toggle for at least two cycles of the clock signal CLK, the reset control circuit 210 may enable all the first to fourth reset signals RST1, RST2, RST3 and RST4.

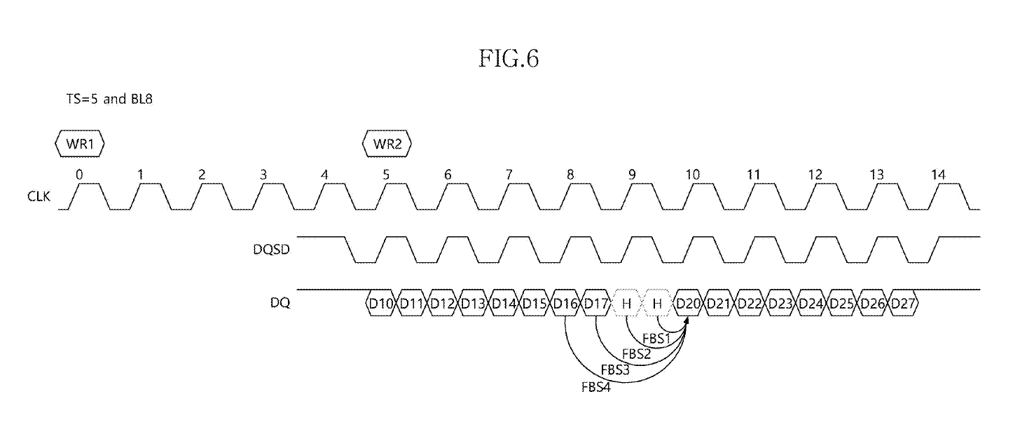

FIG. 6 is a timing diagram illustrating operations of the receiving circuit 200 and the semiconductor system 1 when a time information is 5 (TS=5) and a burst length information is 8 (BL8). First to eighth data D10, D11, D12, D13, D14, D15, D16 and D17 associated with a first write operation may be inputted in synchronization with the strobe signal DQSD in fifth to eighth cycles of the clock signal CLK, and first to eighth data D20, D21, D22, D23, D24, D25, D26 and D27 associated with a second write operation may be inputted in synchronization with the strobe signal DQSD in tenth to thirteenth cycles of the clock signal CLK. In a ninth cycle of the clock signal CLK, the strobe signal DQSD may not toggle and also data DQ may not be received. Referring to FIG. 6, while it appears that the strobe signal DQSD toggles in the ninth cycle of the clock signal CLK, the strobe signal DQSD may not toggle actually because the strobe signal DQSD has a postamble indicating the end of the first write operation and a preamble indicating the start of the second write operation. Therefore, the first delay circuit 241 may retain the level of the first feedback signal FBS1 based on the level of the eighth data D17, the second delay circuit 242 may retain the level of the second feedback signal FBS2 based on the level of the seventh data D16, the third delay circuit 243 may retain the level of the third feedback signal FBS3 based on the level of the sixth data D15, and the fourth delay circuit 244 may retain the level of the fourth feedback signal FBS4 based on the level of the fifth data D14. Since the strobe signal DQSD does not toggle for one cycle of the clock signal CLK, when the receiving circuit 200 receives the first data D20 associated with the second write operation, the feedback signals based on the seventh and eighth data D16 and D17 are needed for decision feedback equalization, but the feedback signals based on the fifth and sixth data D14 and D15 are not needed for decision feedback equalization. Therefore, the third and fourth delay circuits 243 and 244 which output the third and fourth feedback signals FBS3 and FBS4 may be reset. However, the third feedback signal FBS3 generated based on the eighth data D17 and the fourth feedback signal FBS4 generated based on the seventh data D16 are needed for decision feedback equalization for the first data D20 associated with the second write operation.

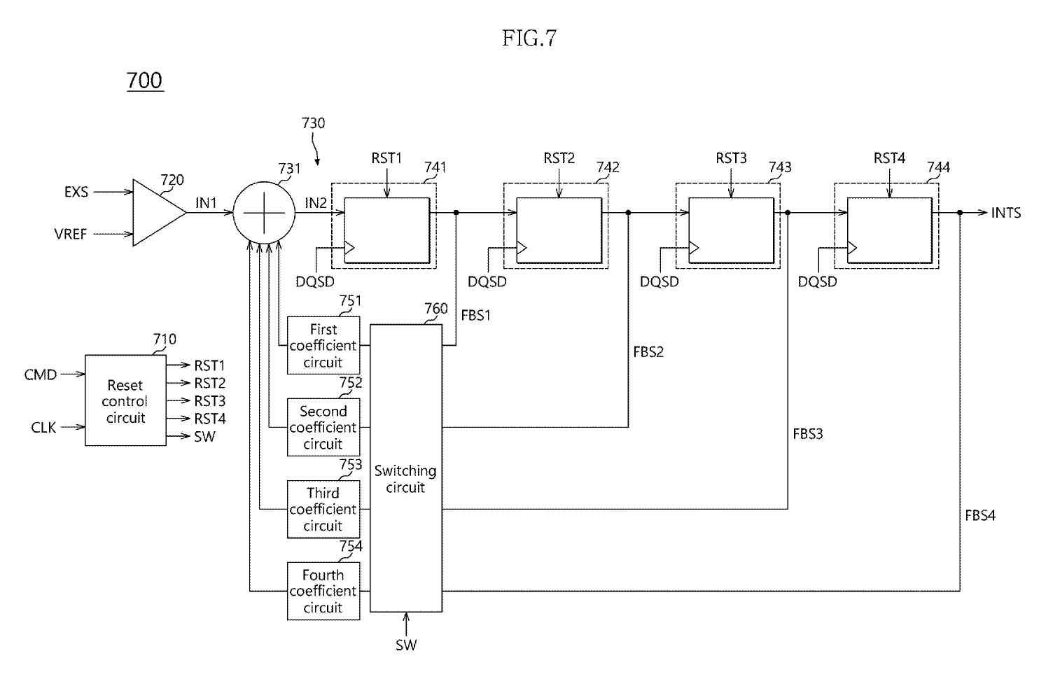

FIG. 7 is a diagram illustrating a representation of an example of the configuration of a receiving circuit 700 in accordance with an embodiment. Referring to FIG. 7, the receiving circuit 700 may include a reset control circuit 710, a buffer 720, a decision feedback equalizer circuit 730, and a summer 731. The receiving circuit 700 may have a configuration similar to the receiving circuit 200 illustrated in FIG. 2 except some components. Similar reference numerals are used to refer to the same or similar components as or to the components of the receiving circuit 200 among the components of the receiving circuit 700, and repeated descriptions for the same components will be omitted herein. Referring to FIG. 7, the reset control circuit 710 may additionally generate a switching signal SW together with first to fourth reset signals RST1, RST2, RST3 and RST4 based on operation information. The receiving circuit 700 may further include a switching circuit 760. The switching circuit 760 may receive first to fourth feedback signals FBS1, FBS2, FBS3 and FBS4 outputted from first to fourth delay circuits 741, 742, 743 and 744, and output the first to fourth feedback signals FBS1, FBS2, FBS3 and FBS4 to first to fourth coefficient circuits 751, 752, 753 and 754 based on the switching signal SW. The switching circuit 760 may switch the first to fourth feedback signals FBS1, FBS2, FBS3 and FBS4 and the first to fourth coefficient circuits 751, 752, 753 and 754 based on the switching signal SW. For example, when the switching signal SW is a disabled state, the switching circuit 760 may output the first feedback signal FBS1 to the first coefficient circuit 751, output the second feedback signal FBS2 to the second coefficient circuit 752, output the third feedback signal FBS3 to the third coefficient circuit 753, and output the fourth feedback signal FBS4 to the fourth coefficient circuit 754. When the switching signal SW is an enabled state, the switching circuit 760 may output the first feedback signal FBS1 to the third coefficient circuit 753, output the second feedback signal FBS2 to the fourth coefficient circuit 754, output the third feedback signal FBS3 to the first coefficient circuit 751, and output the fourth feedback signal FBS4 to the second coefficient circuit 752. The reset control circuit 710 may enable the switching signal SW when the operation information is specified operation information. The reset control circuit 710 may enable the switching signal SW when time information and burst length information have specified values. For example, when time information is 5 (TS=5) and burst length information is 8 (BL8) as in FIG. 6, the reset control circuit 710 may not reset the first and second delay circuits 741 and 742 by disabling the first and second reset signals RST1 and RST2, and may reset the third and fourth delay circuits 743 and 744 by enabling the third and fourth reset signals RST3 and RST4. The reset control circuit 710 may enable the switching signal SW, and the switching circuit 760 may output the first and second feedback signals FBS1 and FBS2 to the third and fourth coefficient circuits 753 and 754 instead of the first and second coefficient circuits 751 and 752. Thus, even though the strobe signal DQSD does not toggle as in FIG. 6, the feedback signals based on the seventh and eighth data D16 and D17 may be utilized for decision feedback equalization for the first data D20 associated with the second write operation.

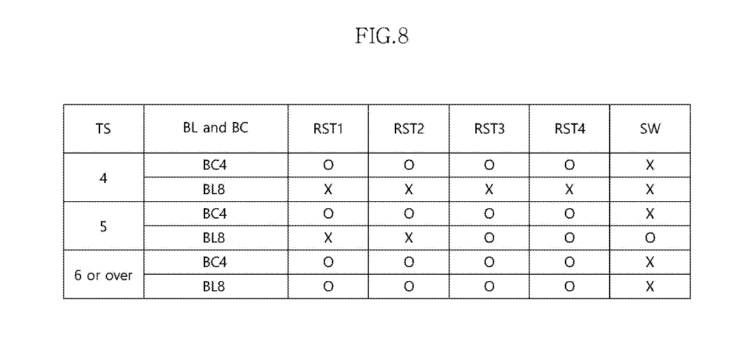

FIG. 8 is a representation of an example of a table to assist in the explanation of the operation of the reset control circuit 710 illustrated in FIG. 7. An operation when a time information TS is 4 and a burst length information BL is 8 may correspond to the timing diagram illustrated in FIG. 5a, and the reset control circuit 710 may disable the first to fourth reset signals RST1, RST2, RST3 and RST4 and the switching signal SW. An operation when a time information TS is 4 and a burst chop information BC is 4 may correspond to the timing diagram illustrated in FIG. 5b, and the reset control circuit 710 may enable the first to fourth reset signals RST1, RST2, RST3 and RST4 and disable the switching signal SW. An operation when a time information TS is 5 and a burst chop information BC is 4 may correspond to the timing diagram illustrated in FIG. 5c, and the reset control circuit 710 may enable the first to fourth reset signals RST1, RST2, RST3 and RST4 and disable the switching signal SW. An operation when a time information TS is equal to or larger than 6 may correspond to the timing diagram illustrated in FIG. 5d, and the reset control circuit 710 may enable the first to fourth reset signals RST1, RST2, RST3 and RST4 and disable the switching signal SW. An operation when a time information TS is 5 and a burst length information BL is 8 may correspond to the timing diagram illustrated in FIG. 6. At this time, the reset control circuit 710 may disable the first and second reset signals RST1 and RST2, enable the third and fourth reset signals RST3 and RST4, and enable the switching signal SW. Therefore, the third and fourth delay circuits 743 and 744 may be reset, the first delay circuit 741 may output the first feedback signal FBS1 generated based on the eighth data D17 to the switching circuit 760, and the second delay circuit 742 may output the second feedback signal FBS2 generated based on the seventh data D16 to the switching circuit 760. The switching circuit 760 may output the first feedback signal FBS1 to the third coefficient circuit 753 and output the second feedback signal FBS2 to the fourth coefficient circuit 754, based on the enabled switching signal SW. Accordingly, when the receiving circuit 700 receives the first data D20, decision feedback equalization may be performed according to the feedback signals based on the signals outputted from the third and fourth coefficient circuits 753 and 754, that is, the seventh and eighth data D16 and D17.

While various embodiments have been described above, it will be understood to those skilled in the art that the embodiments described are examples only. Accordingly, the receiving circuit, and the semiconductor device and system using the same described herein should not be limited based on the described embodiments.

What is claimed is:

1. A receiving circuit comprising:
a reset control circuit configured to generate a plurality of reset signals based on operation information;
a buffer configured to receive an external signal and to generate an input signal; and
a decision feedback equalizer circuit including a plurality of delay circuits, and configured to generate an internal signal based on the input signal and outputs of the plurality of delay circuits, wherein the plurality of delay circuits are reset based on the plurality of reset signals, respectively.

2. The receiving circuit according to claim 1, wherein the operation information includes time information as a time interval from a time point at which a previous write operation has been performed to when a next write operation is performed.

3. The receiving circuit according to claim 1, wherein the operation information includes burst length information and burst chop information.

4. The receiving circuit according to claim 1, wherein the decision feedback equalizer circuit comprises:
a summer configured to generate a corrected signal by summing the input signal, a first feedback signal, a second feedback signal, a third feedback signal and a fourth feedback signal;
a first delay circuit configured to generate the first feedback signal by delaying the corrected signal based on a strobe signal, and to be reset based on a first reset signal;
a second delay circuit configured to generate the second feedback signal by delaying the first feedback signal based on the strobe signal, and to be reset based on a second reset signal;
a third delay circuit configured to generate the third feedback signal by delaying the second feedback signal based on the strobe signal, and to be reset based on a third reset signal; and
a fourth delay circuit configured to generate the fourth feedback signal by delaying the third feedback signal based on the strobe signal, and to be reset based on a fourth reset signal,
wherein the fourth feedback signal is provided as the internal signal.

5. The receiving circuit according to claim 4, wherein the decision feedback equalizer circuit further comprises:
a first coefficient circuit configured to compute the first feedback signal and a first coefficient, and to provide a computed result to the summer;
a second coefficient circuit configured to compute the second feedback signal and a second coefficient, and to provide a computed result to the summer;
a third coefficient circuit configured to compute the third feedback signal and a third coefficient, and to provide a computed result to the summer; and
a fourth coefficient circuit configured to compute the fourth feedback signal and a fourth coefficient, and to provide a computed result to the summer.

6. The receiving circuit according to claim 5, wherein the decision feedback equalizer circuit further comprises:
a switching circuit configured to switch the first to fourth feedback signals and the first to fourth coefficient circuits based on a switching signal.

7. The receiving circuit according to claim 6, wherein the reset control circuit generates the first to fourth reset signals based on the operation information, and enables the switching signal when the operation information are specified operation information.

8. The receiving circuit according to claim 4, wherein the strobe signal is a clock signal which toggles only when the external signal is inputted.

9. A receiving circuit comprising:
a reset signal generation circuit configured to generate a first reset signal, a second reset signal, a third reset signal and a fourth reset signal based on a time information, a burst length information and a burst chop information;
a buffer configured to receive an external signal and to generate an input signal; and
a decision feedback equalizer circuit including a first delay circuit, a second delay circuit, a third delay circuit and a fourth delay circuit, and configured to generate an internal signal based on the input signal and first to fourth feedback signals respectively generated from the first to fourth delay circuits, wherein the first to fourth delay circuits are reset based on the first to fourth reset signals.

10. The receiving circuit according to claim 9, wherein the reset signal generation circuit comprises:
a counter configured to generate the time information based on a command and a clock signal; and
a reset signal generator configured to generate the first to fourth reset signals based on the time information, the burst length information and the burst chop information.

11. The receiving circuit according to claim 10, wherein the time information corresponds to a time interval from a point of time at which a previous write operation has been performed to when a next write operation is performed.

12. The receiving circuit according to claim 9,
wherein the decision feedback equalizer circuit further includes a summer which generates a corrected signal by summing the input signal and the first to fourth feedback signals,
wherein the first delay circuit generates the first feedback signal by delaying the corrected signal based on a strobe signal,
wherein the second delay circuit generates the second feedback signal by delaying the first feedback signal based on the strobe signal,
wherein the third delay circuit generates the third feedback signal by delaying the second feedback signal based on the strobe signal, and
wherein the fourth delay circuit generates the fourth feedback signal by delaying the third feedback signal based on the strobe signal.

13. The receiving circuit according to claim 12, wherein the first delay circuit comprises:
a first flip-flop configured to output the corrected signal as the first feedback signal in synchronization with the strobe signal, based on the first reset signal.

14. The receiving circuit according to claim 12, wherein the second delay circuit comprises:
an input logic configured to output selectively the first feedback signal based on the second reset signal; and
a second flip-flop configured to output an output of the input logic as the second feedback signal in synchronization with the strobe signal.

15. The receiving circuit according to claim 12, wherein the third delay circuit comprises:
an input logic configured to output selectively the second feedback signal based on the third reset signal; and
a third flip-flop configured to output an output of the input logic as the third feedback signal in synchronization with the strobe signal.

16. The receiving circuit according to claim 12, wherein the fourth delay circuit comprises:
an input logic configured to output selectively the third feedback signal based on the fourth reset signal; and
a fourth flip-flop configured to output an output of the input logic as the fourth feedback signal in synchronization with the strobe signal.

17. The receiving circuit according to claim 12, wherein the decision feedback equalizer circuit further includes:
a first coefficient circuit configured to compute the first feedback signal and a first coefficient, and to provide a computed result to the summer;
a second coefficient circuit configured to compute the second feedback signal and a second coefficient, and to provide a computed result to the summer;
a third coefficient circuit configured to compute the third feedback signal and a third coefficient, and to provide a computed result to the summer; and
a fourth coefficient circuit configured to compute the fourth feedback signal and a fourth coefficient, and to provide a computed result to the summer.

18. The receiving circuit according to claim 17, wherein the decision feedback equalizer circuit further includes a switching circuit which switches the first to fourth feedback signals and the first to fourth coefficient circuits based on a switching signal.

19. The receiving circuit according to claim 18, wherein the reset signal generation circuit enables the switching signal when the time information and the burst length information have specified values.

20. The receiving circuit according to claim 12, wherein the strobe signal is a clock signal which toggles only when the external signal is inputted.

21. A receiving circuit comprising:
a buffer configured to receive an external signal and to generate an input signal; and
a decision feedback equalizer circuit including a plurality of delay circuits, and configured to generate an internal signal based on the input signal, a strobe signal, and outputs of the plurality of delay circuits,
wherein the plurality of delay circuits are reset based on whether or not the strobe signal has toggled or not between command signals.

22. The receiving circuit according to claim 21, further comprising:
a reset control circuit configured to generate a plurality of rest signals based on operation information included in the command signals,
wherein the plurality of delay circuits are reset based on the plurality of reset signals, respectively.
